(19) United States
(12) Patent Application Publication
(10) Pub. No.: US 2026/0213581 A1
(43) Pub. Date: Jul. 23, 2026

(54) Systems and Methods for Treating Sleep-Related Breathing Disorders

(71) Applicant: The Regents of the University of California, Oakland, CA (US)

(72) Inventors: Aydin Babakhani, Los Angeles, CA (US); Hamed Rahmani, Belle Mead, NJ (US); Hidemasa Mitsui, Santa Clara, CA (US); Sepideh Nouri, Santa Monica, CA (US)

(73) Assignee: The Regents of the University of California, Oakland, CA (US)

(21) Appl. No.: 19/638,803

(22) Filed: Apr. 3, 2026

Related U.S. Application Data
(63) Continuation-in-part of application No. 19/423,987, filed on Dec. 17, 2025.
Application No. 19/423,987 is a continuation of application No. 18/391,277, filed on Dec. 20, 2023, now Pat. No. 12,531,438.
Application No. 18/391,277 is a continuation of application No. 17/929,959, filed on Sep. 6, 2022, now Pat. No. 12,062,926.
Application No. 17/929,959 is a continuation of application No. 17/456,328, filed on Nov. 23, 2021, now Pat. No. 11,515,733.
Application No. 17/456,328 is a continuation of application No. PCT/US2021/020343, filed on Mar. 1, 2021.
(60) Provisional application No. 62/983,494, filed on Feb. 28, 2020.
(60) Provisional application No. 63/136,096, filed on Jan. 11, 2021.
(60) Provisional application No. 63/783,008, filed on Apr. 3, 2025.

(51) Int. Cl. H02J 50/27; H02J 50/00

(52) U.S. Cl. CPC H02J 50/27; H02J 50/001

(57) ABSTRACT

A system for hypoglossal nerve stimulation (HNS) includes a wearable device comprising at least one sensor, at least one wirelessly powered stimulator, and a controller device. The wearable device is configured to receive a control input describing stimulation data, provide a radio frequency (RF) signal to the at least one wirelessly powered stimulator, and monitor at least one physiological signal of a subject. Each wirelessly powered stimulator comprises an implantable pulse generator comprising a rectifier, a rechargeable battery configured to be charged by the rectifier using energy from the RF signal, a demodulator, and an output voltage regulator. Each implantable pulse generator is configured to receive the RF signal, charge the rechargeable battery, and output a stimulation using stored energy in an output pulse having characteristics based on the received RF signal.

### CROSS-REFERENCE TO RELATED APPLICATIONS

The present application claims benefit under 35 U.S.C. 119(e) to U.S. Provisional Patent Application No. 63/783,008, entitled “Systems and Methods for Treating Sleep-Related Breathing Disorders” to Babakhani et al., filed Apr. 3, 2025, and is also a continuation-in-part of U.S. patent application Ser. No. 19/423,987, entitled “Integrated Energy Harvesting Transceivers and Transmitters With Dual-Antenna Architecture for Miniaturized Implants and Electrochemical Sensors” to Babakhani et al., filed Dec. 17, 2025, which is a continuation of U.S. patent application Ser. No. 18/391,277 entitled “Integrated Energy Harvesting Transceivers and Transmitters With Dual-Antenna Architecture for Miniaturized Implants and Electrochemical Sensors” to Babakhani et al., filed Dec. 20, 2023 and issued as U.S. Pat. No. 12,531,438 on Jan. 20, 2026, which is a continuation of U.S. patent application Ser. No. 17/929,959, entitled “Integrated Energy Harvesting Transceivers and Transmitters With Dual-Antenna Architecture for Miniaturized Implants and Electrochemical Sensors” to Babakhani et al., filed Sep. 6, 2022 and issued as U.S. Pat. No. 12,062,926 on Aug. 13, 2024, which is a continuation of U.S. patent application Ser. No. 17/456,328, entitled “Integrated Energy Harvesting Transceivers and Transmitters With Dual-Antenna Architecture for Miniaturized Implants and Electrochemical Sensors” to Babakhani et al., filed Nov. 23, 2021 and issued as U.S. Pat. No. 11,515,733 on Nov. 29, 2022, which is a continuation of PCT Patent Application No. PCT/US2021/020343, entitled “Integrated Energy Harvesting Transceivers and Transmitters With Dual-Antenna Architecture for Miniaturized Implants and Electrochemical Sensors” to Babakhani et al., filed Mar. 1, 2021, which claims priority to U.S. Provisional Application No. 63/136,096, entitled “Wirelessly Powered Chemical/PH Sensor with Integrated Radio and Power” to Babakhani et al., filed Jan. 11, 2021, and U.S. Provisional Application No. 62/983,494, entitled “Integrated Energy Harvesting Transceiver Based on a Dual-Antenna Architecture for Miniaturized Implants” to Yu et al., filed Feb. 28, 2020, the disclosures of which are incorporated herein by reference in their entirety.

### FIELD OF THE INVENTION

The present invention generally relates to wirelessly powered transceivers and transmitters, specifically to small form-factor transceivers and transmitters achieving high energy efficiency and data throughput while staying as small as possible, which can be used for biomedical implants and/or electrochemical sensors in environmental applications.

### BACKGROUND

Sleep-related breathing disorders (SRBDs) are a category of sleep disorders characterized by abnormal respiratory patterns during sleep, leading to disruptions in normal breathing and oxygenation. These disorders can range from mild snoring to more severe conditions such as sleep apnea and hypoventilation syndromes. SRBDs can have significant health consequences, including daytime fatigue, cognitive impairment, and an increased risk of cardiovascular diseases, metabolic disorders, and even premature mortality if left untreated. The primary cause of these disorders varies, but they often involve structural or neurological dysfunctions that interfere with normal airway patency or respiratory control.

Obstructive sleep apnea (OSA) is the most common type of sleep-related breathing disorder, marked by repeated episodes of partial or complete obstruction of the upper airway during sleep. This occurs when the muscles in the throat relax excessively, leading to a temporary blockage that causes breathing to stop momentarily. These interruptions, known as apneic events, can last for several seconds and occur multiple times per hour, often resulting in loud snoring, choking, or gasping for air. OSA not only disrupts sleep but also contributes to serious health complications such as high blood pressure, heart disease, and an increased risk of stroke.

### SUMMARY OF INVENTION

Systems and methods for treating sleep-related breathing disorders using wirelessly powered implantable pulse generators with closed-loop multimodal monitoring in accordance with embodiments of the invention are illustrated. One embodiment includes a system for hypoglossal nerve stimulation (HNS). The system includes a wearable device comprising at least one sensor, at least one wirelessly powered stimulator, and a controller device. The wearable device is configured to receive a control input describing stimulation data, provide a radio frequency (RF) signal to the at least one wirelessly powered stimulator based on the control input, and monitor, using the at least one sensor, at least one physiological signal of a subject implanted with the at least one wirelessly powered stimulator. Each wirelessly powered stimulator includes an implantable pulse generator comprising a rectifier, a rechargeable battery configured to be charged by the rectifier using energy from the RF signal, a demodulator, and an output voltage regulator. Each implantable pulse generator is configured to receive the RF signal, charge the rechargeable battery using energy from the RF signal, and output a stimulation using energy stored in the rechargeable battery in an output pulse having characteristics based on the received RF signal. The controller device is capable of providing the control input describing stimulation data.

In another embodiment, the at least one sensor includes at least one selected from: an Electromyography (EMG) sensor, Electroencephalography (EEG), Electrooculography (EOG), a reflective photoplethysmography (PPG) sensor, an acoustic sensor, a piezoelectric sensor, a MEMS sensor, an accelerometer, a magnetometer, and a gyroscope.

In a further embodiment, the at least one physiological signal is selected from the group consisting of: oxygen saturation levels; AHI index; snoring sounds; body position; respiratory effort; respiratory rate; heart rate; heart rate variability; apneas; and hypopneas.

In still another embodiment, the at least one physiological signal includes a stage of sleep, wherein the stage of sleep includes: Rapid Eye Movement (REM), Non-Rapid Eye Movement (NREM), Stage N1 (Light Sleep), Stage N2 (Deeper Light Sleep), and Stage N3 (Deep Sleep/Slow-Wave Sleep).

In a still further embodiment, the controller device is configured to apply different stimulation parameters during different detected stages of sleep.

In yet another embodiment, the controller device is capable of adjusting and outputting the stimulation based on the monitored at least one physiological signal.

In a yet further embodiment, the controller device utilizes machine learning algorithms to dynamically adjust stimulation parameters based on the monitored at least one physiological signal.

In another additional embodiment, the machine learning algorithms include at least one selected from: reinforcement learning, convolutional neural networks (CNNs), long short-term memory (LSTM) networks, and temporal convolutional networks (TCNs).

In a further additional embodiment, data from the at least one sensor is synchronized and analyzed in real time to provide a multimodal evaluation of sleep-related breathing disorder events.

In another embodiment again, the implantable pulse generator utilizes a voltage-controlled stimulation (VCS) scheme in which a VDD node is directly applied to an electrode with a controllable pulse width.

In a further embodiment again, the implantable pulse generator further includes a transmitter configured to transmit data to the wearable device, and the wearable device is configured to adjust the RF signal based on the transmitted data from the implantable pulse generator.

In still yet another embodiment, the at least one sensor is located on at least one of the wearable device or the implantable pulse generator.

One embodiment includes a system for hypoglossal nerve stimulation (HNS). The system includes a wearable device comprising at least one sensor, at least one wirelessly powered stimulator, and a controller device. The wearable device is configured to receive a control input describing stimulation data, provide a radio frequency (RF) signal to the at least one wirelessly powered stimulator based on the control input, and monitor, using the at least one sensor, at least one physiological signal of a subject implanted with the at least one wirelessly powered stimulator. Each wirelessly powered stimulator includes an implantable pulse generator comprising a rectifier, an energy storage capacitor, a demodulator, and an output voltage regulator. Each implantable pulse generator is configured to receive and recover power from the RF signal and output a stimulation that releases the energy stored in the energy storage capacitor on a plurality of electrodes in an output pulse having characteristics based on the received RF signal. The controller device is capable of providing the control input describing stimulation data.

One embodiment includes a method for treating obstructive sleep apnea (OSA) in a subject. The method includes providing a radio frequency (RF) signal from a wearable device to a wirelessly powered implantable pulse generator (IPG) implanted in the subject proximate to the hypoglossal nerve, recovering, by the IPG, power from the RF signal, and outputting, by the IPG using the recovered power, a stimulation to the hypoglossal nerve of the subject in an output pulse having characteristics based on the received RF signal. The method further includes monitoring, by the wearable device, at least one physiological signal of the subject, generating, by a controller device, an adjusted control input describing stimulation data based on the monitored at least one physiological signal, and providing an adjusted RF signal from the wearable device to the IPG based on the adjusted control input.

In another embodiment, monitoring the at least one physiological signal includes monitoring at least one selected from the group consisting of: oxygen saturation levels; AHI index; snoring sounds; body position; respiratory effort; respiratory rate; heart rate; heart rate variability; apneas; and hypopneas.

In a further embodiment, the method further includes classifying a sleep stage of the subject based on the monitored at least one physiological signal, and applying different stimulation parameters during different classified stages of sleep.

In still another embodiment, recovering power from the RF signal includes rectifying the RF signal and storing recovered power in an energy storage capacitor.

In a still further embodiment, recovering power from the RF signal includes rectifying the RF signal and charging a rechargeable battery.

In yet another embodiment, the adjusted control input is encoded in the RF signal using a notch-based modulation scheme in which RF power is reduced to a percentage of RF power during harvest to encode stimulation timing information.

In a yet further embodiment, generating the adjusted control input includes utilizing machine learning algorithms to dynamically adjust stimulation data based on the monitored at least one physiological signal.

One embodiment includes a wearable device for wireless powering and closed-loop control of an implantable pulse generator. The wearable device includes a radio frequency (RF) transmitter coil configured to transmit a wireless signal to wirelessly power the implantable pulse generator, a plurality of physiological sensors comprising at least a blood oxygen saturation sensor, an acoustic sensor, and a motion sensor, a wireless communication module configured to communicate with a controller device, and a processor. The processor is configured to acquire physiological data from the plurality of physiological sensors, process the physiological data using at least one machine learning algorithm, and modulate the wireless signal to encode adjusted stimulation data based on the processed physiological data.

In another embodiment, the at least one machine learning algorithm includes a Long Short-Term Memory (LSTM) network or Temporal Convolutional Network (TCN) for processing blood oxygen saturation data.

In a further embodiment, the at least one machine learning algorithm includes a Convolutional Neural Network (CNN) for classifying apneic events from acoustic sensor data.

In still another embodiment, the RF transmitter coil is configured to transmit the wireless signal at approximately 13.56 MHz.

In a still further embodiment, the motion sensor is a three-axis accelerometer.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

FIG. 1 illustrates a comparison between a current HNS system and a novel closed-loop HNS system in accordance with an embodiment of the invention.

FIG. 2A illustrates an example implementation of a wireless IPG for HNS in accordance with an embodiment of the invention.

FIG. 2B illustrates a system architecture of an IPG in accordance with an embodiment of the invention.

FIG. 2C illustrates a schematic of a Tx coil in accordance with an embodiment of the invention.

FIG. 3 illustrates a wearable device for wireless powering and controlling an IPG in accordance with an embodiment of the invention.

FIG. 4 illustrates a list of components to be included in a wearable device in accordance with an embodiment of the invention.

FIG. 5 illustrates a process for closed-loop HNS in accordance with an embodiment of the invention.

FIG. 6A illustrates a block diagram of a transceiver system in accordance with an embodiment of the invention.

FIG. 6B illustrates a block diagram of another transceiver system in accordance with an embodiment of the invention.

FIG. 7A graphically illustrates an example of duty-cycling power in a miniaturized implant in accordance with an embodiment of the invention.

FIG. 7B graphically illustrates power being sufficient for a transmit block to remain active all the time in accordance with an embodiment of the invention.

FIG. 8 illustrates a flow chart illustrating a process for the optimization algorithm for the power link in accordance with an embodiment of the invention.

FIG. 9 illustrates optimal dimensions of an on-chip coil and a dipole antenna according to an embodiment of the invention.

FIG. 10 illustrates a diagram of a power harvesting system in accordance with an embodiment of the invention.

FIG. 11 illustrates a circuit schematic of a receiver circuitry block and the corresponding waveforms in accordance with an embodiment of the invention.

FIG. 12 illustrates switching status of transistors in positive and negative cycles in a receiver circuitry block in accordance with an embodiment of the invention.

FIG. 13 illustrates a timing diagram in accordance with an embodiment of the invention.

FIG. 14 illustrates a circuit schematic of a Schmitt trigger in accordance with an embodiment of the invention.

FIG. 15 illustrates an equivalent model for a power oscillator (PO) in accordance with an embodiment of the invention.

FIG. 16 illustrates a circuit schematic of a reconfigurable TX and the corresponding waveforms in operating modes in accordance with an embodiment of the invention.

### DETAILED DESCRIPTION

Sleep-related breathing disorders (SRBDs), such as obstructive sleep apnea (OSA), have been difficult to treat. OSA is primarily caused by anatomical and physiological factors such as obesity, airway structure, and muscle tone, but it may also be influenced by lifestyle, genetics, and comorbidities like hypertension or diabetes. Due to these various reasons and patient variabilities, developing treatment plans that can cater to individual patients can be difficult.

One of the biggest challenges in treating OSA is patient adherence to continuous positive airway pressure (CPAP) therapy, which is the gold standard for treatment. CPAP requires wearing a mask that delivers constant airflow to keep the airway open during sleep, but many patients struggle with discomfort, dryness, claustrophobia, or noise from the machine, leading to poor compliance. Alternative treatments, such as oral appliances or surgical interventions, can be helpful for some but are not universally effective. The variability in symptoms, severity, and underlying causes makes OSA management a challenge, often requiring a combination of interventions and ongoing adjustments to find the most effective approach for each patient.

Additionally, CPAP treatment requires titration studies to determine the optimal air pressure needed to keep a patient's airway open during sleep. These studies are typically conducted during an overnight visit to a specialized sleep facility or, alternatively, through the use of an auto-adjusting CPAP (APAP) machine at home. Titration studies can be expensive and time-consuming or in the case of using APAPs, prolonged home adjustments may not always be accurate. Titration studies can be expensive and time-consuming, while APAP-based home adjustments may take longer and are not always accurate.

In recent years, hypoglossal nerve stimulation (HNS) has emerged as an alternative therapy for OSA. HNS leverages implantable pulse generators (IPGs) to provide stimulation, which has the potential to be a superior treatment for OSA compared to traditional methods like CPAP. Unlike CPAP, which forces air through the airway, hypoglossal nerve stimulators work by electrically stimulating the hypoglossal nerve and the genioglossus muscle, which controls tongue and airway muscle movement, to prevent airway collapse during sleep. HNS can address the root cause of airway obstruction by providing stimulation to open airways without requiring external equipment.

Current HNS systems, however, often involve the invasive implantation of sensing leads and a bulky battery, which can complicate the procedure and recovery process. Due to these structural complexities, current HNS systems have experienced manufacturing defects, such as electrical leakage in the sensing circuit, which have led to FDA recalls to address potential malfunctions and safety concerns. Furthermore, currently-available HNS systems also lack real-time adaptability to patient-specific physiological changes, such as variations in apnea-hypopnea index (AHI), oxygen desaturation index (ODI), body position, or sleep stage, which can limit the therapeutic efficacy of HNS systems and reduce patient comfort.

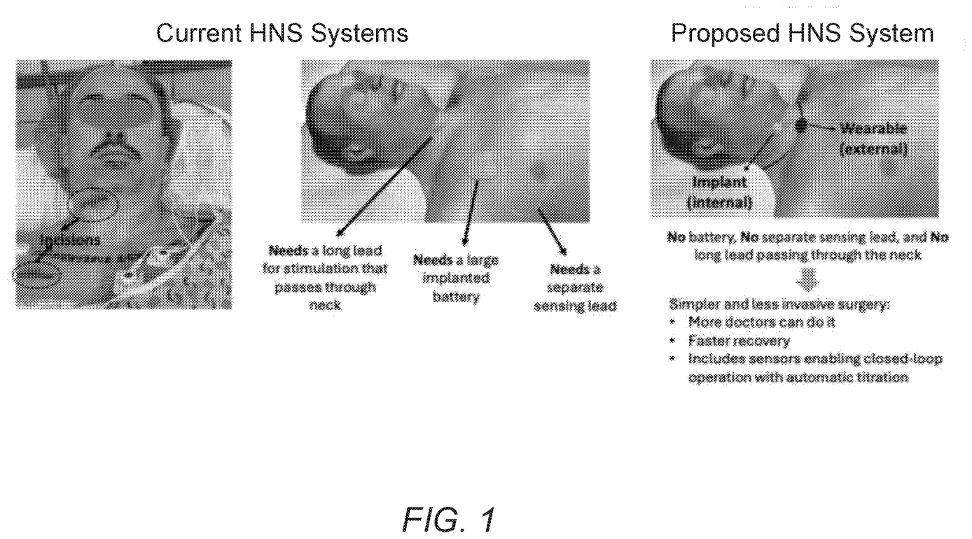

A comparison between a current HNS system and the novel closed-loop HNS system in accordance with an embodiment of the invention is illustrated in FIG. 1. Current HNS systems, as illustrated in FIG. 1, require large incisions to implant long stimulation leads that extend from the patient's chest through the neck to the genioglossus muscle. Additionally, they rely on large, implanted batteries to power the system, along with separate sensing leads to monitor the patient's breathing patterns. The multiple implanted components not only contribute to patient discomfort but also pose potential risks if any device malfunctions or deteriorates inside the body.

Systems and methods in accordance with various embodiments of the invention provide novel closed-loop HNS systems that are powered wirelessly through a wearable device that integrates multimodal sensors for real-time physiological monitoring. HNS systems in accordance with many embodiments of the invention leverage small form factor stimulation devices implanted near the genioglossus muscle to drastically reduce the bulk of the system as compared to current HNS systems. By eliminating the need for implanted sensing leads and a battery, HNS systems in accordance with many embodiments are also minimally invasive to address the critical limitations of current devices in order to improve efficacy, comfort, and patient adherence. Various embodiments provide closed-loop monitoring of the patient such that stimulation parameters can be adapted accurately in real time without the need for titration studies. HNS systems in accordance with numerous embodiments can improve OSA management and significantly enhance patients' quality of life.

### Wireless Power Transfer

Unlike current HNS systems requiring implanted batteries, HNS systems in accordance with many embodiments utilize concepts of wireless power transfer to wirelessly power an IPG fabricated on stimulator implants and eliminate the need for battery replacement surgeries and reduce overall invasiveness. HNS systems can enable higher power densities while minimizing tissue interference and ensuring patient safety. In several embodiments, HNS systems provide miniaturization and robust performance in dynamic environments, essential for wearable-enabled closed-loop systems.

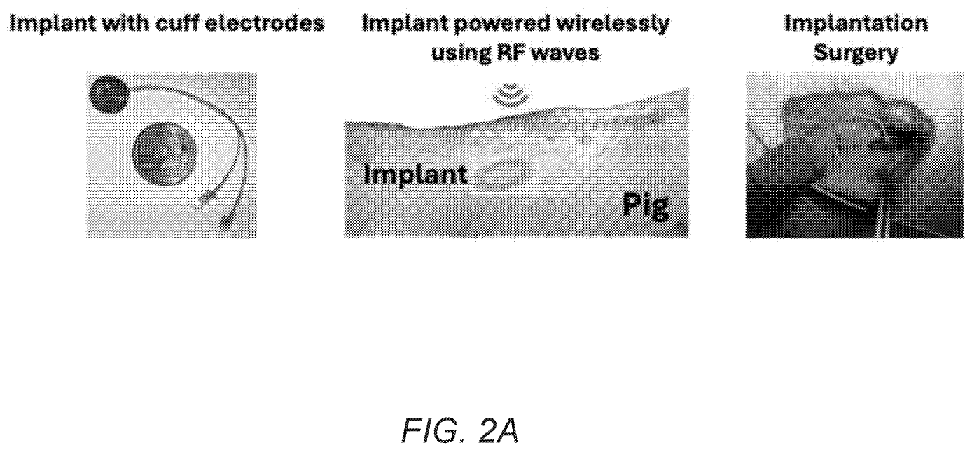

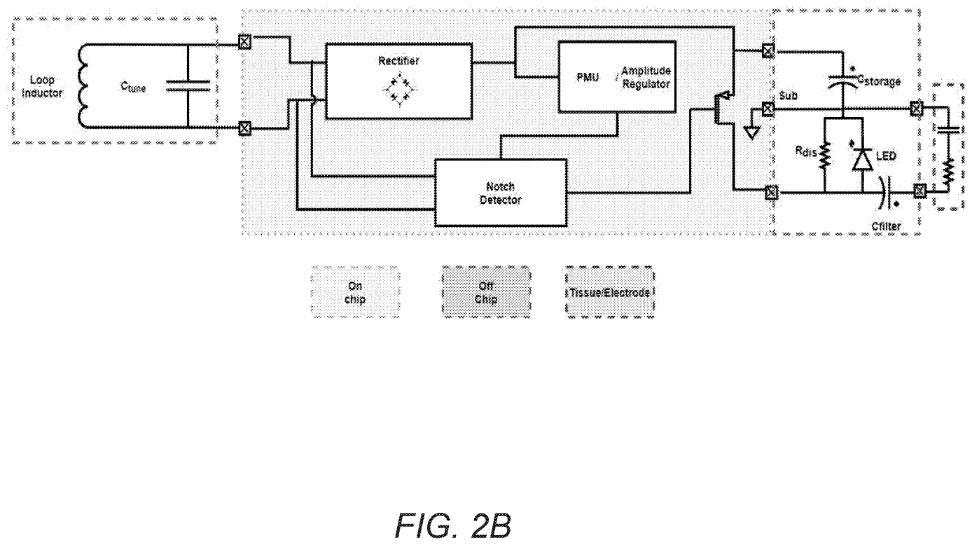

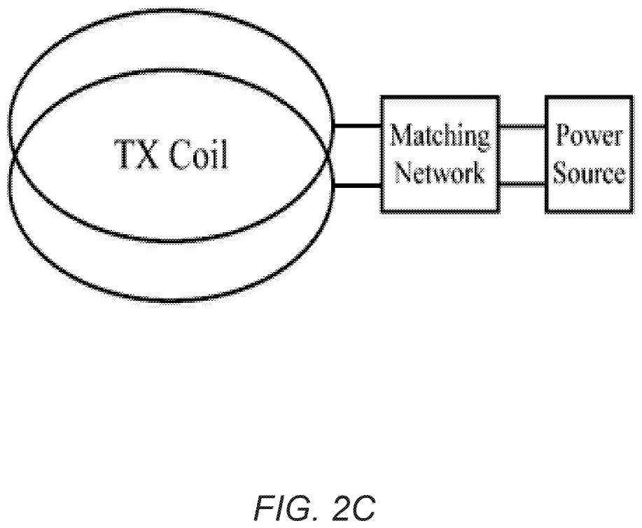

Many embodiments utilize a resonant inductive coupling system optimized for continuous power delivery to the IPG during sleep. HNS systems in accordance with various embodiments integrate feedback data from sensors to dynamically optimize stimulation parameters. An example implementation of a wireless IPG for HNS in accordance with an embodiment of the invention is illustrated in FIG. 2A. IPGs in accordance with various embodiments have a very small form factor such that patients experience minimal discomfort after implantation.

A system architecture of an IPG in accordance with an embodiment of the invention is illustrated in FIG. 2B. In many embodiments, the magnetic field coupled to the Rx coil can be rectified to generate VDD and charge an energy storage capacitor, C_{STORAGE}. In several embodiments, notches (e.g., RF power is reduced to a percentage of the RF power during harvest) can be intentionally applied in the Tx signal, which precisely controls the timing of the output stimulations as their repetitions. The notch-based modulation scheme can eliminate any complex telemetry and minimize power consumption. In many embodiments, as the notches only constitute a negligible portion of the Tx power, they do not degrade the efficiency of the power transfer link. Various embodiments utilize a VCS scheme for better energy efficiency, in which the VDD node can be directly applied to the electrode/tissue with a controllable pulse width. In many embodiments, a simplified output voltage regulator may be used in place of a low-dropout (LDO) to limit the amplitude of the output stimulations within a specific range, which may further reduce the static power consumption. Regulators in accordance with a number of embodiments can enable the notch-demodulation block only when the supply voltage exceeds the lower tier. When the supply voltage exceeds the higher tier, a discharge path may be enabled to rapidly discharge the excess incident charge. The stimulations can be delivered through a DC-block capacitor, C_{FILTER}, for charge-neutralization. In several embodiments, a discharge resistor, R_{DIS}, nulls the accumulated charge on C_{FILTER}. A light-emitting diode (LED) can be optionally included at the output to visually identify that stimulation is occurring. Although FIG. 2A illustrates a particular circuit architecture of an IPG, any of a variety of circuit architectures may be utilized as appropriate to the requirements of specific applications in accordance with embodiments of the invention.

In several embodiments, there are five discrete components used on the stimulator PCB. The rectifier resonance frequency can be tuned using a tuning capacitor where C_{TUNE} equals 47 PF. Power can be continuously harvested on a discrete storage capacitor where C_{STORAGE} equals 22 mF. A series filtering capacitor with C_{FILTER} being 10 mF and parallel discharge resistor RDISD=47 kΩ may be assembled at the output such that the charge is balanced.

In many embodiments, IPGs can be wirelessly powered and controlled by a custom Tx coil fabricated using a 1.6 mm FR4 substrate with six turns on each side. Tx coils in accordance with a variety of embodiments have a diameter of approximately 45 mm. In certain embodiments, the wideband Tx coil sweeps at different frequencies to find the resonant frequency of the Rx energy-harvesting frontend to achieve the minimum power to activate the output. In an embodiment of the invention, the resonant frequency for impedance matching was verified at approximately 13.56 MHz. To ensure maximum power delivery from the signal generator, the transmitter coil can be matched to 50 ohms. S11 measured using the VNS (PNA-L network analyzer) Model N5230C shows better than −38.4 dB matching and, therefore, a terminal efficiency higher than 99.99%. Although FIG. 2B illustrates a particular schematic of a Tx coil, any of a variety of architectures may be utilized as appropriate to the requirements of specific applications in accordance with embodiments of the invention.

In selected embodiments, the inductor on the receiver side is resonated with a high-quality factor (Q>200) 47 pF capacitor for maximum current delivery. Unlike the transmitter coil, the inductance cannot be directly measured due to the high parasitism of probes and the relatively small size of receiver coils. In an embodiment of the invention, the simulated quality factor for the Rx coil (Qr) is 65.2. The link efficiency is a function of mutual coupling (k) according to the equation:

$$η \approx \frac{{K}^{2} {Q}_{t} Qr}{{( 1 + \sqrt{{K}^{2} {Q}_{t} Qr} )}^{2}} . \qquad ( 1 )$$

To maximize link efficiency, mutual coupling should be maximized. In several embodiments, variations in coupling with respect to distance and angular misalignment can be simulated using HFSS (Ansys Inc.) simulations, and the point at which coupling decreases by half (−3 dBm power) can be found. IPGs and wireless power transfer are further described in PCT Application PCT/US2022/081388 to Babakhani et al., entitled Systems and Methods for Vagus Nerve Stimulation with Closed-Loop Monitoring, the disclosure of which is incorporated by reference herein in its entirety.

### Wearable Device

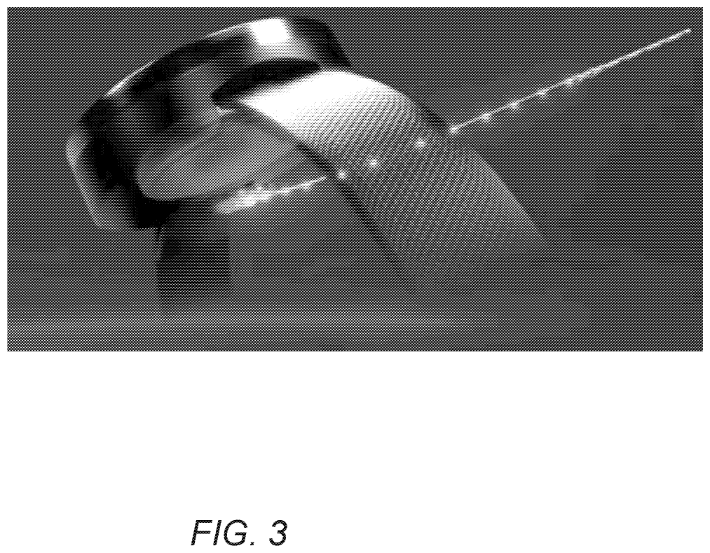

A wearable device for wireless powering and controlling an IPG is illustrated in FIG. 3. Wearable devices in accordance with various embodiments include multiple sensors to measure oxygen saturation (SpO₂) levels, respiratory sounds, and body position of the wearer to provide a comprehensive physiological profile to guide real-time therapy adjustments.

SpO₂ is a critical parameter for detecting and managing OSA. The SpO₂ sensor may be a reflective photoplethysmography (PPG) sensor for SpO₂ monitoring, such as the Texas Instruments AFE4404 and OPT3001, which are optimized for wearable applications with low power consumption and high signal fidelity. The reflective design can provide reliable performance even when integrated into compact, flexible wearables. SpO₂ sensors in accordance with various embodiments provide continuous monitoring of oxygen levels and can detect hypoxic events in real-time, triggering corrective stimulation adjustments.

Wearable devices in accordance with many embodiments include acoustic sensors such as the Knowles SPH0645LM4H-B MEMS microphone or the Analog Devices ADMP401 for detecting respiratory sounds and snoring. Respiratory sounds and snoring can be vital indicators of airway obstruction. High-sensitivity MEMS microphones can provide robust performance in low-noise environments and are suited for capturing subtle respiratory sounds during sleep. By processing acoustic signals, the wearable device can differentiate between normal breathing, snoring, and apnea events, further refining the closed-loop control algorithms. The microphone's small size and low power requirements can allow for seamless integration without compromising the wearable's compact design.

In several embodiments, wearable devices include accelerometers such as STMicroelectronics LIS2DW12 or Analog Devices ADXL362 for body position and motion tracking. Body position and motion may significantly impact the severity of OSA events. Accelerometers can continuously track changes in body posture and motion, providing valuable context for interpreting SpO₂ and acoustic data. For example, positional data can help determine whether apneas are related to supine sleeping and guide position-based therapy interventions.

Although a specific example of a wearable device for HNS is illustrated in this figure, any of a variety of setups can be utilized to perform processes for HNS similar to those described herein as appropriate to the requirements of specific applications in accordance with embodiments of the invention.

In many embodiments, data collected from these sensors are synchronized and analyzed in real time, providing a multimodal understanding of the patient's condition. This sensor fusion approach allows for a more accurate and holistic evaluation of OSA events compared to single-sensor systems. The wearable device may include advanced noise cancellation and filtering techniques to ensure signal reliability and minimize artifacts caused by motion or environmental factors.

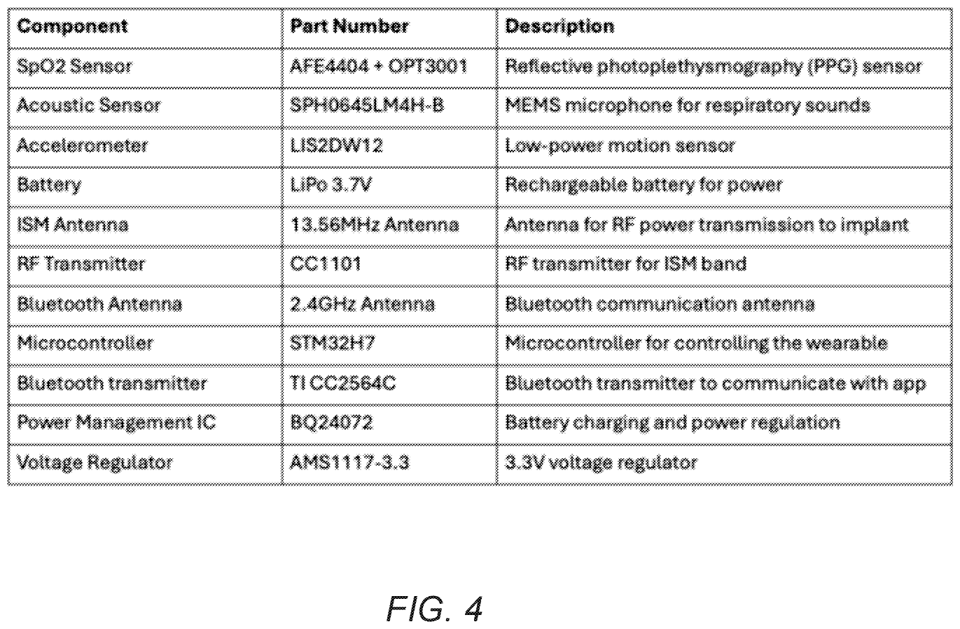

Sensors described above in accordance with several embodiments are mounted within the wearable device's flexible housing, ensuring comfort and durability during sleep. A list of components to be included in a wearable device in accordance with an embodiment of the invention is illustrated in FIG. 4. For stable functioning, wearable devices in many embodiments include additional components beyond the multiple sensors discussed above as outlined in FIG. 4. Sensors in the wearable device can work synergistically to create a complete physiological profile, ensuring that the closed-loop HNS system can dynamically adjust its parameters to meet the patient's specific needs.

### Closed-Loop Monitoring

HNS systems in accordance with various embodiments include closed-loop monitoring to obtain and analyze valuable patient data in the course of treatment to determine if the treatment needs to be adjusted. In numerous embodiments, adaptive machine learning algorithms dynamically adjust HNS stimulation parameters based on real-time data from wearable sensors. Adjustment algorithms in accordance with several embodiments utilize multimodal sensor inputs, including SpO₂, respiratory sounds, and accelerometer data, to provide a holistic view of the patient's physiological state. Reinforcement learning frameworks may be employed to fine-tune parameters such as stimulation amplitude, frequency, and duration, allowing for precise and timely adjustments. Some embodiments utilize convolutional neural networks (CNNs) and long short-term memory (LSTM) models to process complex patterns in the data, ensuring accurate detection of apnea events and dynamic responses to physiological changes. By leveraging these advanced methods, HNS systems in accordance with a variety of embodiments can optimize therapeutic efficacy while minimizing side effects such as muscle fatigue and overstimulation.

SpO₂ data may be analyzed using LSTM networks temporal convolutional networks (TCNs) by modeling the temporal dependencies in blood oxygen saturation levels to identify apnea-related fluctuations with high precision. Data from acoustic sensors may be analyzed by utilizing CNNs to analyze spectrograms of respiratory sounds to classify snoring and apnea events. Hybrid CNN-RNN architectures may be employed to capture both spatial and temporal features, following research indicating high accuracy in acoustic sleep apnea detection. Transformers or lightweight 1D-CNNs may be utilized to process motion data from the accelerometer to detect positional changes and correlate them with apnea severity and frequency. In several embodiments, HNS systems integrate feedback mechanisms to adjust HNS stimulation dynamically, preventing overstimulation while maintaining airway patency. The closed-loop control system can utilize real-time data collected from the wearable's multimodal sensors, including SpO₂ levels, respiratory sounds, and body position to determine the appropriate level of stimulation to deliver.

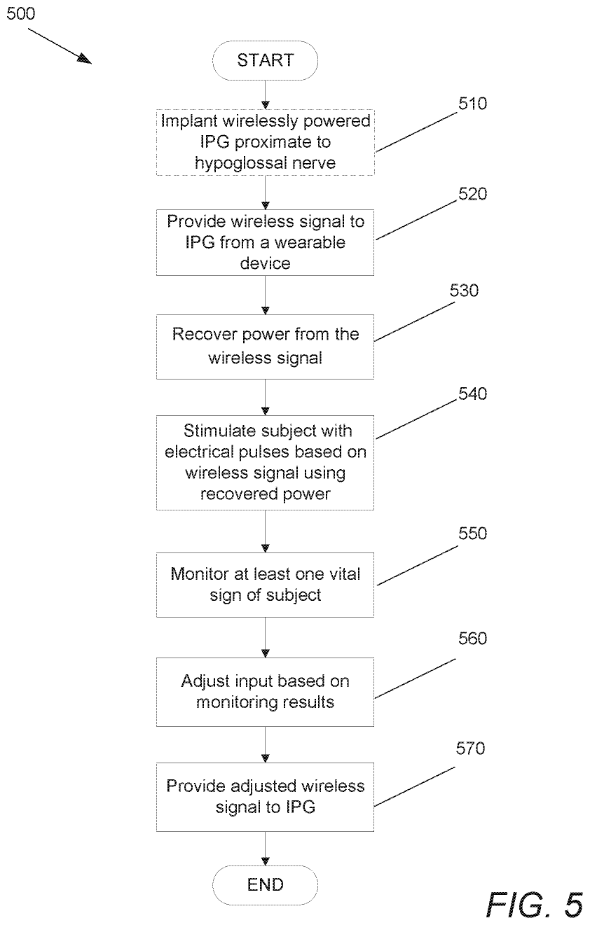

A process for closed-loop HNS in accordance with an embodiment of the invention is illustrated in FIG. 5. Process 500 optionally includes implanting (510) an IPG into the subject proximate to the hypoglossal nerve. Various embodiments include IPGs that can be powered up using 0.1 W of power at 13.56 MHz.

Process 500 provides (520) a wireless signal to the IPG from a wearable device. The wireless signal may include information indicating the desired level of stimulation to be administered to the subject, as discussed further above.

Process 500 recovers (530) power from the wireless signal and stimulates (540) the subject with electrical pulses using the IPG powered by the recovered power and based on the wireless signal. In many embodiments of the invention, IPGs can receive a wireless signal that not only powers the IPGs but also provides information on pulse intensity and the timing of output electrical pulses, as enabled by the circuits discussed above.

Process 500 monitors (550) at least one vital sign of the stimulated subject. In many embodiments, at least one vital sign includes at least the blood oxygen level of the subject, which can be calculated, for example, by a PPG measurement as described further above. In various embodiments, vital signs are monitored by the wearable device.

Process 500 adjusts (560) input describing the desired stimulation intensity based on the monitoring results. Wearable devices in accordance with numerous embodiments can transmit monitored vital signs to a controller device. In many embodiments, controller devices receive monitoring results and may determine appropriate adjustments to be made to the stimulation. Adjustments may be performed by a model in the controller device. Process 500 provides (570) adjusted wireless signals to the stimulator.

While specific processes are described above with reference to FIG. 5, any of a variety of methods for providing closed-loop HNS using IPGs in any of a variety of different re-driver modes can be utilized as appropriate to the requirements of specific applications in accordance with various embodiments of the invention.

### Transceiver Architecture

IPGs in accordance with various embodiments of the invention may utilize transceiver architectures for wireless power delivery and data communication. To enable a transceiver to meet severe power constraints, many embodiments of the invention utilize one or more of the following techniques: 1) Co-optimizing the on-chip coil (OCC) and the wireless link with power harvesting circuitry to maximize power transfer efficiency. 2) Exploiting a power management unit (PMU) to set the operating mode and biasing condition of different blocks depending on the available power and power consumption of the system. 3) Utilizing a dual antenna architecture to minimize the interference between power link and transmitter. 4) Exploiting amplitude-based modulation schemes in the transmitter for maximizing energy efficiency. 5) Utilizing a transmitter block architecture based on a power oscillator (PO) to achieve the highest possible energy efficiency. 6) Applying circuit-level power reduction techniques in the PO design. 7) Stacking MOSCAP and MIM capacitors to achieve a high density and realize a ~5 nF on-chip capacitor for energy storage.

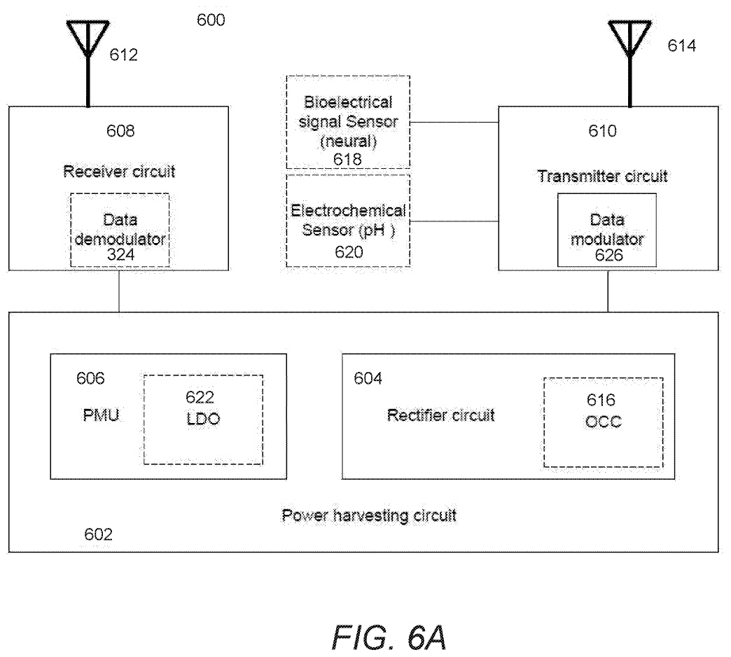

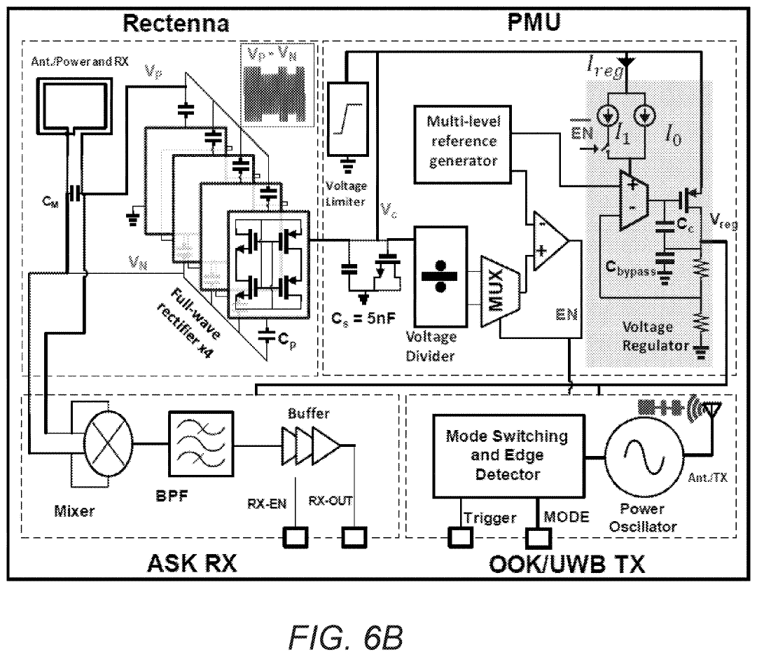

A block diagram of a transceiver system in accordance with several embodiments of the invention is depicted in FIG. 6A. The transceiver system 600 includes a power harvesting system 602, which includes a rectenna (rectifier circuit) 604 and a power management unit (PMU) 606, a receiver circuit (RX) 608, and a transmitter circuit (TX) 610. A receive antenna 612 is connected to the receiver circuit 608 and a transmit antenna 614 is connected to the transmitter circuit 610.

The rectenna 604, which may include an on-chip coil (OCC) 616, four full-wave rectifiers and a matching capacitor, can receive energy through an inductive link and convert RF energy into a DC voltage. The OCC can be shared between the power harvesting system 602 (for power) and the receiver 608 (for receiving data). The converted power by the rectenna can be used to power other components of the transceiver system 600 such as the data transmitter.

The receiver circuit 608 may include a data demodulator 624 to receive data at the transceiver system. Some embodiments may not receive data and therefore may not have a data decoder in the receive circuit. Some embodiments may extract a clock signal from the received signal. In some embodiments, the receive antenna 612 is a loop antenna with a capacitor to utilize resonance inductive coupling. In other embodiments, the receive antenna 612 is a dipole antenna and other configurations may be contemplated.

In several embodiments, the transmitter 610 includes a reconfigurable data modulator circuit 626 to send data out from the system. In different embodiments of the invention, the transmit antenna 614 can be a monopole, dipole, or loop antenna as appropriate to a particular application, although isolation from the receive antenna 612 is desirable.

The main power-consuming block of the system is often the transmitter (TX) 610. Due to the challenges of power transfer to mm-sized implants, harvested power is often less than the instantaneous power consumption of the TX block 610. Therefore, power management unit (PMU) 606 can duty-cycle the operation of the data TX 610 to maintain a minimum voltage across the storage capacitor (C_{S}) and establish charging and discharging modes for C_{S}. In charging mode, the converted power by the rectenna increases the voltage level across C_{S} (V_{C}) until the PMU 606 activates the TX block 610. The PMU 606 and data receiver (RX) 608 blocks can be active during the entire operation and constituent sub-circuits may be designed in subthreshold region to maximize sensitivity and reduce the charging time of C_{S}. On the other hand, discharging time of C_{S} is proportional to the capacitance value; hence using a large capacitance enables the PMU 606 to follow rapid transitions of V_{C}. In several embodiments of the invention, in order to achieve a high capacitance density, MIM capacitors (1 fF/μm²) are stacked over MOSCAP devices (5.5 fF/μm²) to realize a 5 nF capacitor, although other designs may be utilized to achieve a target capacitance. The transition from charging mode to discharging mode represents a significant load variation for the low dropout voltage regulator (LDO) 622 in the PMU 606. To ensure the regulator remains functional, the bandwidth of the error amplifier can be increased at the onset of active mode. The PMU 606 can adaptively change the bias condition of the LDO and enable it to maintain a constant voltage at its output.

In several embodiments of the invention, a transceiver for a neural recording application (e.g., neural stimulation) can receive information from a bioelectrical signal sensor 618. A bioelectrical signal sensor 618 can include any of a variety of biosensors and neural sensors, such as, but not limited to, neural LFP (local field potential), electrocardiogram (ECG), compound action potential, electromyogram (EMG), Electroencephalogram (EEG), Electromyogram (EMG), Electrooculogram (EOG), Electroretinogram (ERG), and/or Electrogastrogram (EGG). Such sensors may sense electrical signals, potential, or other characteristics in a variety of ways such as the difference between two electrodes, electrical resistance, or the magnetic field induced by electrical currents. Such neural recording applications may complement neural stimulation for a variety of therapies, such as pain control. The voltages and frequency (ranging from few Hz to kHz) may be selected for noise purposes and to reject DC frequencies.

FIG. 6B conceptually illustrates another transceiver system in accordance with embodiments of the invention. Although specific transceiver systems are described above with respect to FIGS. 6A and 6B, one skilled in the art would recognize that certain components of the system described above may be different, may have different characteristics, or be different in number in accordance with embodiments of the invention as appropriate to a particular application. Further discussion of circuit designs that may be utilized for power management, power harvesting and transfer, and frequency selection and optimization of a wireless link can be found in “A Dual-Mode RF Power Harvesting System With an On-Chip Coil in 180-nm SOI CMOS for mm-Sized Biomedical Implants” by Hamed Rahmani and Aydin Babakhani (October 2018, IEEE Transactions on Microwave Theory and Techniques), the relevant portions of which are incorporated by reference.

### Wireless Communication

The required data rate of transmitter circuitry (TX) and receiver circuitry (RX) paths in medical implants varies considerably and thus the communication is typically asymmetric. The wireless link from an external reader to the RX, which can be referred to as downlink (DL), typically has a data rate that does not exceed a few Mbps. On the other hand, the wireless link from the TX to an external reader, which can be referred to as uplink (UL), typically has a large bandwidth to support data rates up to hundreds of Mbps. In other embodiments of the invention, the transceiver does not need to receive data in a downlink channel and may only utilize the received signal for power and/or clock signal.

In many embodiments that receive data via downlink, the data is incorporated into the received signal with an Amplitude-Shift-Keying (ASK) modulation scheme. The RX block can be directly powered by the power harvesting system and may be active during the entire operation of the system. To enable simultaneous UL and DL communication, several embodiments utilize Frequency Division Duplexing (FDD) for transmitting UL and set the center frequency in the GHz region. Such a high center frequency alleviates the undesired effects of the strong power link on the TX communication and minimizes the interference of UL and DL. In many embodiments, the UL communication incorporates amplitude-based modulation schemes due to their superior energy efficiency and less sensitivity to supply variation as opposed to frequency-based modulation schemes. In various embodiments of the invention, the TX block can be configured to transmit UL data with either OOK or Ultra-Wideband (UWB) modulation.

In many embodiments, a 250 MHz signal is utilized to power the chip by received signal as it provides high penetration, and higher harmonics of this frequency can cause interference. Additionally, the received power signal may utilize amplitude modulation. In several embodiments, a 4.15 GHz center frequency is utilized for the transmit signal to provide high data rates. To avoid any interference between the uplink and downlink communication, a 4.15 GHz can be used for the transmitter. The design supports data rates of up to 2.5 Mbps in the receiver and data rates of up to 150 Mbps in the transmitter chain, respectively.

The PMU can convert the unregulated output voltage of the rectifier to a constant DC voltage and adjust the power consumption of the entire system. The maximum harvested power in mm-sized implants is often less than the power consumption of a power-hungry block such as a data TX. One technique to tackle this problem is duty-cycling the operation of power-demanding blocks and lowering the overall power consumption of the system. Depending on the power consumption of each block, the PMU can set its power delivery scheme to either continuous or duty-cycled. A storage capacitor (C_{S}) is used for storing the converted energy by the rectifier and a voltage limiter is included in the PMU to prevent any voltage breakdown. The most power-demanding block of the system is typically the data TX. Therefore, the PMU monitors the voltage level across C_{S} and establishes active and sleep modes for the TX operation.

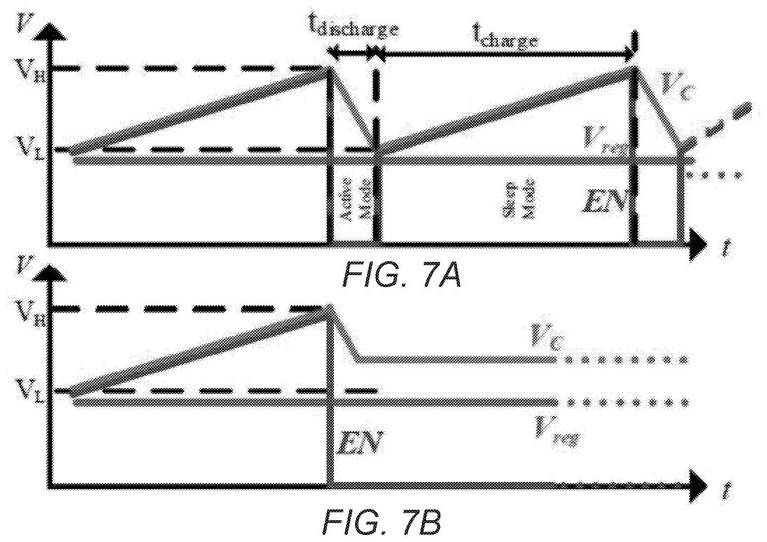

An example of duty-cycling power in a miniaturized implant in accordance with embodiments of the invention is illustrated in FIG. 7A. If the harvested power falls below TX power consumption, the TX block can be periodically deactivated by an enable (EN) signal to allow the PMU to maintain V_{C} higher than a minimum threshold amount (V_{L}) that is required for continuous operation of the RX block and internal circuitry of the PMU. For the entire duration of the sleep mode (t_{charging}), the rectifier charges the C_{S} and V_{C} rises until it reaches a predefined threshold (V_{H}). If the harvested power is sufficient for continuous operation, the TX block remains active all the time, EN stays low and V_{C} settles at a voltage level between V_{H} and V_{L}, as shown in FIG. 7B.

### Wireless Link Implementation

The wireless link of the transceiver system in accordance with several embodiments of the invention includes two distinct antennas that are used in DL and UL paths (the receive and transmit blocks). Mm-sized RF wireless power transfer (WPT) systems featuring an on-chip coil (OCC) as power receiver can have an operating frequency (receive) in the order of few tens or hundreds of MHz. To minimize the interference of the WPT system, the operating frequency of the data TX is extended to the GHz frequency region in several embodiments. Among various types of antennas, a dipole structure is an attractive choice for the UL path due to its simple profile and compatibility with on-chip integration. To enhance the harvested power for the system operation and maximize the data rate in the UL path, it is desirable to optimize the antenna dimensions and operating frequency.

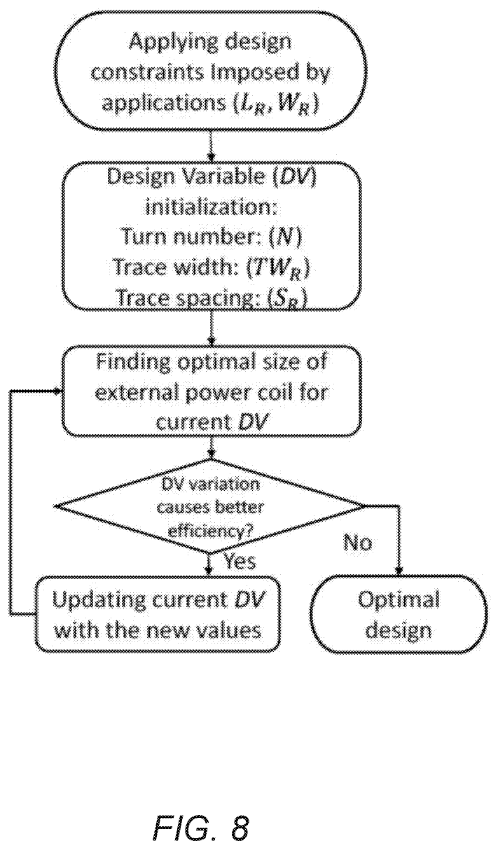

For wireless power harvesting systems for small implants, link optimization, optimum operating frequency, the effect of intervening biological tissues, SAR limit, and rectifier design are of particular interest. The wireless link can be modeled as a two-port network and the link optimization can be conducted through an iterative algorithm that aims to maximize the power transfer efficiency. The two-port network model for a wireless link is a general approach and can be applied to any wireless link operating at near-field or far-field electromagnetic region with different link composition surrounding the antennas. Therefore, the two-port network model can be applied for both DL and UL design of the transceiver. A flow chart illustrating a process for the optimization algorithm for the power link in accordance with some embodiments of the invention is shown in FIG. 8.

To recover larger amounts of power from the DL, it may be desirable to have a large signal. However, this can have undesirable effects on the transmitter. Therefore, a tunable capacitor may be utilized to change the resonance frequency of the receive antenna.

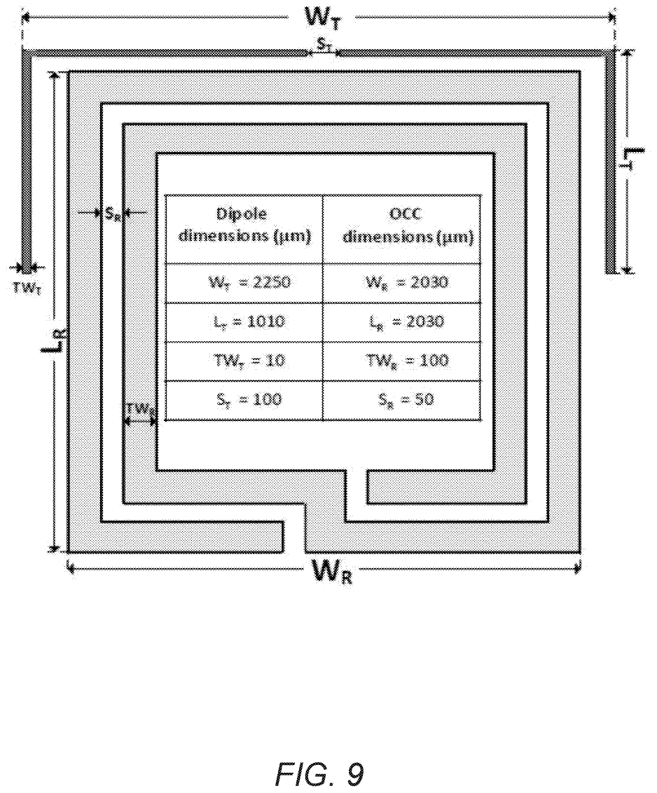

The optimal dimensions of the OCC and the dipole antenna according to several embodiments of the invention are illustrated in FIG. 9. Simulation results show that the illustrated OCC has an inductance value of 13.6 nH and achieves an unloaded Q-factor of 14.3 at 250 MHz. For UL communication, the transceiver in some embodiments utilizes an on-chip dipole that transmits TX data to an external UWB monopole antenna with a bandwidth of 3-7 GHz. The power transfer efficiency of the WPT system is susceptible to degradation by the presence of conductive material in the proximity of the power transmitter coil. To ensure that wireless power flow to the system is not altered by the UWB monopole antenna, the UL communication distance can be chosen to be 15 cm in some embodiments. The optimized design for the dipole antenna can be achieved using a similar optimization algorithm as the WPT system. However, due to the large distance and a weak coupling between the dipole and monopole antennas, the design variables of the monopole antennas may not change through the optimization process.

A calibration process may utilize power with an ideal supply voltage. The received spectrum of the UL can be measured with a spectrum analyzer. The power delivery link can be activated and the tunable capacitor can be tuned until the UL tone (data) is not affected in the presence of the power link. Considering the mm-sized form factor, the maximum dimension of certain embodiments is limited to 2.25 mm and the distance between the external power transmitter and the OCC is set to 12 mm. Due to the relatively large coupling between the external coil and the OCC, the design variables of the OCC can be jointly optimized with the external power coil through an iterative optimization algorithm.

For UL communication, the transceiver in some embodiments utilizes an on-chip dipole that transmits TX data to an external UWB monopole antenna. The power transfer efficiency of the WPT system is susceptible to degradation by the presence of conductive material in the proximity of the power transmitter coil. The optimized design for the dipole antenna can be achieved using a similar optimization algorithm as the WPT system.

However, due to the large distance and a weak coupling between the dipole and monopole antennas, the design variables of the monopole antennas may not change through the optimization process. For UL communication, the transceiver in some embodiments utilizes an on-chip dipole that transmits TX data to an external UWB monopole antenna with a bandwidth of 3-7 GHz. To ensure that wireless power flow to the system is not altered by the UWB monopole antenna, the UL communication distance can be chosen to be 15 cm in some embodiments.

### Power Management Unit

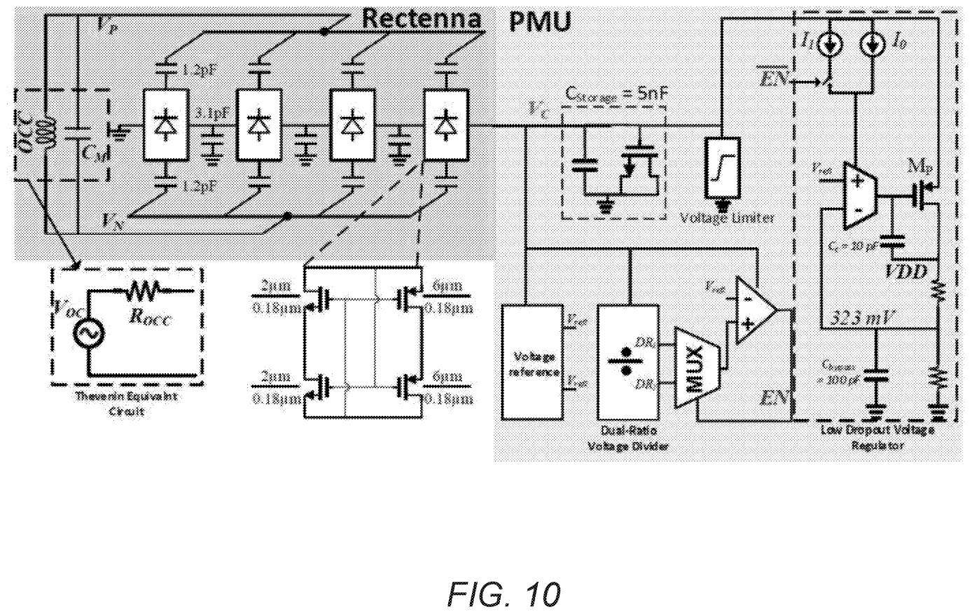

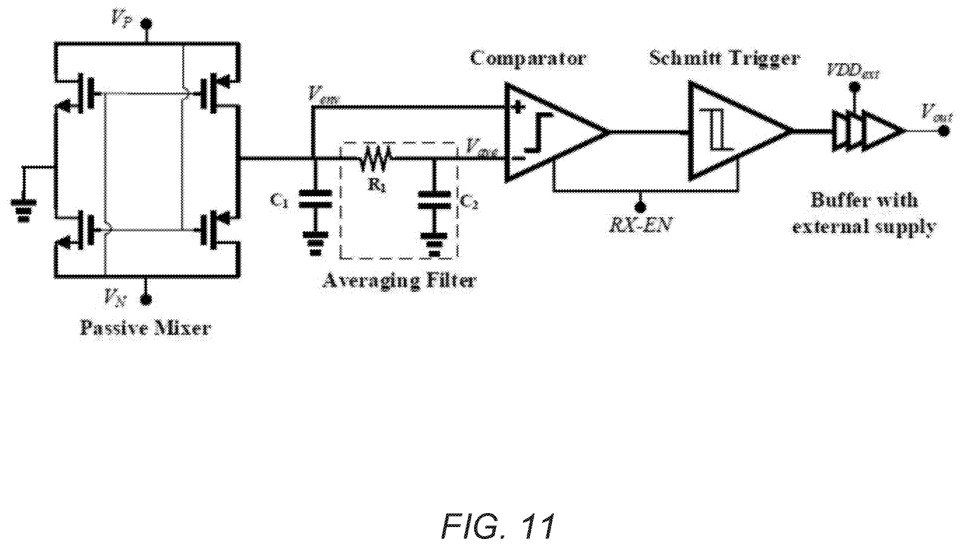

A detailed diagram of a power harvesting system in accordance with several embodiments of the invention is illustrated in FIG. 10. The rectenna may be implemented with a multi-stage full-wave rectifier to ensure V_{C} reaches the required voltage level for the proper operation of the PMU when the transmitted power of the external coil is kept below safety limits. Depending on the received power, and the Q-factor of the OCC, and the matching network, several architectures can be used for implementing a voltage rectifier, including, but not limited to, diode-connected MOS devices, native MOS, threshold-compensated, and self-driven rectifiers. Among various topologies, self-driven rectifiers with cross-coupled CMOS devices can provide a good balance between conversion efficiency and sensitivity. To maximize rectifier RF-DC conversion efficiency, transistor dimensions may be optimized. Moreover, deep N-Well NMOS transistors can be used to allow a direct connection between bulk and source terminals. Connecting bulk to source eliminates body effect and prevents increments of the threshold voltage of NMOS devices that ultimately improves RF-DC conversion efficiency. A first-order matching circuit can be realized using a shunt capacitor that resonates with the OCC and the voltage rectifier at the operating frequency.

The behavior of the PMU in the duty-cycled mode may resemble a hysteresis comparator that is realized using a voltage divider, a multi-level reference generator, a MUX, and a voltage comparator as shown in FIG. 10. The voltage reference block may be realized with a supply independent proportional-to-absolute-temperature (PTAT) architecture to generate two reference voltages. To achieve the highest capacitance value with area constraints of an on-chip design, some embodiments stack MIM capacitors over MOSCAP devices to realize a high-value capacitor.

A low-dropout (LDO) voltage regulator can be incorporated into the PMU 606 to provide a constant 1.3 V DC voltage for the operation of the TX 610 and RX 608 blocks. During charging mode, the total current consumed by the LDO is 10 μA. The transition from sleep mode to the active mode represents a significant load variation for the LDO and a small quiescent current consumption of the LDO limits the transient response of the LDO. Hence, the abrupt variation of the load leads to a large voltage variation at the output of the LDO. The maximum instantaneous current drawn by the TX block 610 reaches as high as 4.5 mA which results in a maximum transient voltage variation of 175 mV. To ensure that the LDO remains functional in the active mode, the bandwidth of the error amplifier is increased at the onset of active mode. The PMU 606 can adaptively increase the bias current of the error amplifier by 100 μA which enables the LDO to maintain the voltage variation below 12 mV. It can ensure that the LDO stability conditions are met during the operation. Simulation results show that the minimum phase margin of the LDO is 88° and the gain margin always remains above 20.5 dB.

The shunt capacitor cancels out the imaginary part of impedance values. Hence, the power reflection between the OCC and the rectifier can be attributed to the difference in the real part of their impedances. An equivalent circuit model for the OCC is illustrated in FIG. 10 where the OCC is modeled as a source with an open circuit voltage of V_{OC} and an internal resistance of R_{OCC}. For a 0 dBm of available power, the simulated conversion efficiency for an available power level of 0 dBm at 250 MHz varies between 30%-65%. Also, the Large Signal S-Parameter (LSSP) simulation of the rectifier indicates that the insertion loss between the OCC and the voltage rectifier is about 4.2 dB. Hence, the overall power transfer efficiency from the external coil to the rectifier is 24.2 dB. On the other hand, the sensitivity of the power harvesting system is defined as the minimum required power transmitted from the external coil to establish a hysteresis operation in the PMU. Based on the simulation results, the sensitivity of the power harvesting system is −21.5 dBm.

Although a specific implementation of a power management unit is discussed above with reference to FIG. 10, one skilled in the art will recognize that any of a variety of designs and characteristics may be utilized in accordance with embodiments of the invention as appropriate to a particular application.

### Data Receiver Design

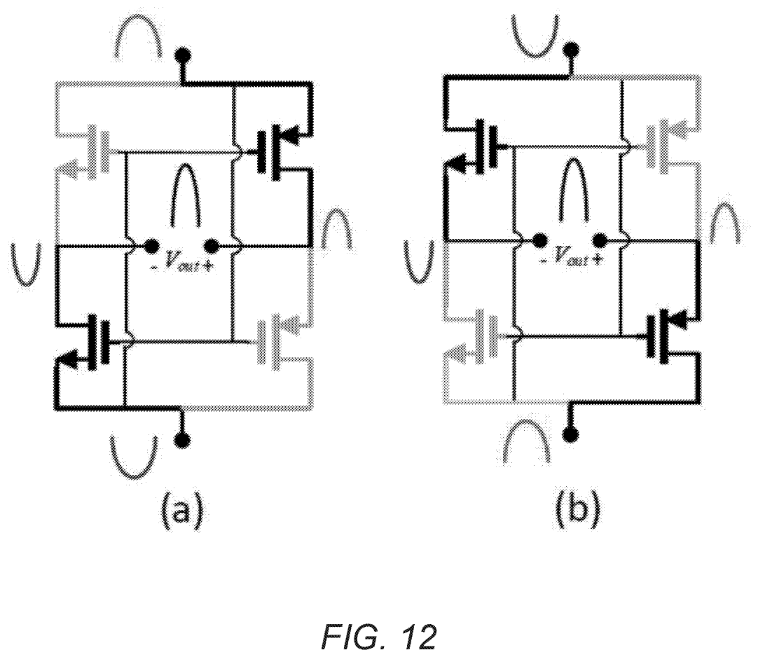

A circuit schematic of the RX block 608 and the corresponding waveforms in accordance with several embodiments of the invention are shown in FIG. 11. The RX is based on a self-mixing architecture. In some embodiments, the power carrier is modulated with an ASK modulation scheme to carry the DL data stream. The received RF signal by the OCC can be formulated as a carrier signal modulated by the data. Data modulation should have a minimal impact on power flow to the chip. Hence, the RX should be able to detect the DL signal with a very small modulation index. A passive mixer may be implemented using the same circuitry as a single rectifier stage to minimize the power consumption of the RX. Switching status of transistors in positive and negative cycles in a receiver circuitry block in accordance with an embodiment of the invention is illustrated in FIG. 12, which reveals that a single rectifier stage can act as a self-mixer.

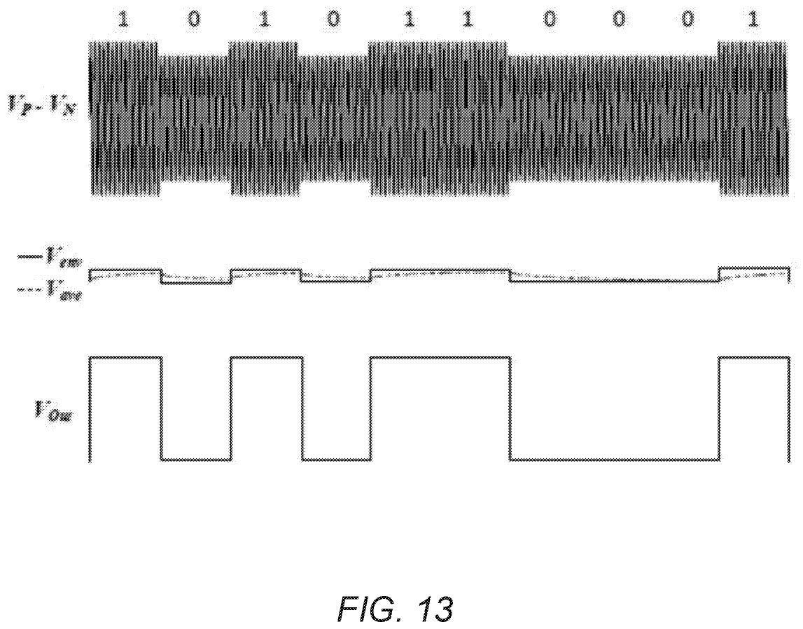

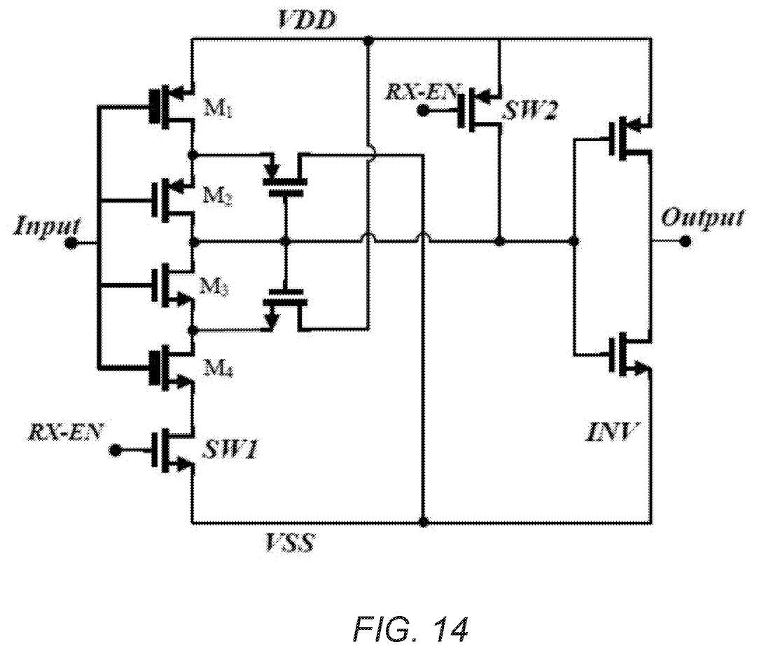

In order to extract DL data, the output of the mixer can be passed from a band-pass filter (BPF) to remove frequency components at DC and high-frequency components. In several embodiments, the BPF is implemented in multiple steps using low-pass filters (LPF) and a voltage comparator. The output node of the mixer may be connected to a shunt capacitor, which forms an LPF with the output resistance of the mixer. The LPF extracts the envelope of the received RF signal. Next, the envelope is passed through another LPF. Due to the large time constant of the LPF, it acts as an averaging filter. To remove the DC component and retrieve the data, the envelope and the averaged signal are passed to the voltage comparator. A timing diagram in accordance with an embodiment of the invention is illustrated in FIG. 13, which shows that if the data does not toggle for multiple consecutive periods, the averaged signal becomes closer to the envelope. As a result, the comparator will be prone to meta-stability. To ensure that the fidelity of the recovered data is preserved, the comparator is followed by a Schmitt trigger that introduces a hysteresis effect. A circuit schematic of the Schmitt trigger in accordance with an embodiment of the invention is demonstrated in FIG. 14. The hysteresis window is set between 385 mV and 935 mV. The hysteresis effect also reduces the noise sensitivity of the RX block.

Although a specific receiver circuitry is described above with respect to FIG. 11, one skilled in the art would recognize that variations may be made or other circuitry may be utilized in accordance with embodiments of the invention as appropriate to a particular application.

### Data Transmitter Design

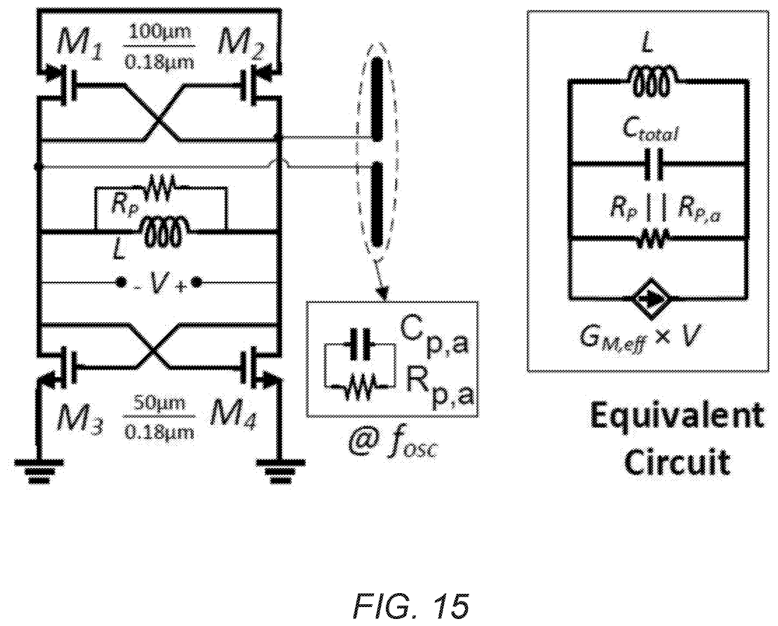

In many embodiments of the invention, the TX block is realized with minimal complexity to reduce overall power consumption. Thanks to the amplitude-based modulation, there is no need for generating an accurate frequency. Therefore, process, voltage, and technology variation can be tolerated which significantly relaxes the constraints on the TX circuit design. As a result, a free-running oscillator is adequate to generate a GHz-range carrier frequency for the TX. To reduce the power consumption of the TX, the transceiver system can utilize a Power Oscillator (PO) as the core of the TX block in several embodiments of the invention. The PO may be directly connected to the dipole antenna and drives it without the need for any extra power consumption in buffers. Hence, many embodiments utilize a co-design approach for the PO and the dipole antenna to set the resonance frequency and maximize the DC-RF efficiency of the TX. An equivalent model for the PO is demonstrated alongside its circuit schematic in FIG. 15. The PO may be realized with a class-D topology where the tail transistor is removed which results in the elimination of the overhead voltage. Unlike conventional oscillators, transistors in class-D operate as close-to-ideal switches. Because of the high oscillation amplitude, this structure is popular for low-phase-noise and low-power applications.

The startup condition of the PO requires that the transconductance of the cross-coupled pair (G_{M}) exceeds the sum of the losses in the tank and the antenna, expressed as G_{M}>1/R_{P}+1/R_{P,a}, where R_{P} is the equivalent parallel resistance of the tank and R_{P,a} is the radiation resistance of the antenna. A complementary cross-coupled pair can be utilized for current reusing and to satisfy the startup condition with lower power consumption. The transistors in the cross-coupled pair may be sized to provide sufficient transconductance while minimizing parasitic capacitance.

The presence of surrounding biological tissues affects the radiation resistance and the resonance frequency of the dipole antenna. In air, the resonance frequency is approximately 4.25 GHz with a radiation resistance of 15.2Ω and DC-RF efficiency of 31.2%. In fat tissue, the resonance frequency shifts to approximately 4.15 GHz with a radiation resistance of 18.7Ω and DC-RF efficiency of 35.1%. In muscle tissue, the resonance frequency is approximately 3.95 GHz with a radiation resistance of 22.3Ω and DC-RF efficiency of 38.5%. The variation in tissue properties necessitates careful design of the PO to ensure reliable operation across different implantation sites.

The coupling efficiency between the power link at 250 MHz and the data link at 4.15 GHz is an important consideration to avoid injection pulling. Simulation results show that the coupling efficiency is −63.4 dB at 250 MHz and −83.7 dB at 4250 MHz, indicating sufficient isolation between the two links to prevent interference.

In various embodiments, the TX block can be configured to conduct UL communication with either OOK or UWB modulation scheme. The circuit schematic of the reconfigurable TX and the corresponding waveforms in both operating modes are depicted in FIG. 18.

In OOK mode, during transmission of a “1” symbol, the PO is active for the entire symbol period T_{S}. The switching between active and inactive states is designed to be smooth to minimize spectral spreading. The power consumption in OOK mode is largely independent of the data rate since the PO operates at a fixed duty cycle determined by the data pattern.

In UWB mode, the PO generates short impulses with duration T_{M}≈2 ns. To achieve fast startup, an asymmetric driving scheme is employed where inverter chain delay lines connect SW2 slightly after SW1. This asymmetric timing allows the cross-coupled pair to build up oscillation rapidly. The startup time of the PO in UWB mode is approximately 200 ps. The transmission gates in the driving circuit are sized approximately 8× larger than the NMOS devices in the cross-coupled pair to ensure sufficient driving capability. The TX block achieves significantly lower average power consumption in UWB mode at the expense of a larger occupied bandwidth.

The trigger signal for enabling the PO is shaped and fed to the TX block according to the modulation type. When operating in OOK mode, the trigger signal replicates the data pattern whereas, in UWB mode, it is shaped as a Return-to-Zero (RZ) waveform. The operating mode of the TX can be controlled by an external mode selection signal that alters the signal path from the trigger to the PO.

In OOK mode, the trigger signal is passed to the PO through a pair of transmission gates to control two switches that connect the NMOS cross-coupled pair to the ground. The switches are realized with NMOS transistors and are sized ×8 larger than the NMOS cross-coupled pair. During transmission of a ‘1’ symbol, the PO is active for the entire symbol period (T_{S}), which results in smooth switching transitions. Consequently, the transmitted signal from the PO occupies less bandwidth and can be detected with a simpler receiver. However, the average power consumption of the TX block in OOK mode is independent of the data rate and is merely determined by the instantaneous power consumption of the PO. In UWB mode, the trigger signal is first passed through a digital circuitry that generates a short impulse (T_{M}≈2 ns) upon the detection of a rising edge in the trigger waveform. Due to the small impulse duration, it is important to ensure that the PO can reliably startup. Asymmetric driving of an oscillator can achieve a fast startup. Therefore, generated impulse is delayed by inverter chain delay lines that connect SW2 slightly after SW1. The current flow during the startup time window through the PO creates an initial voltage difference across node X and Y that results in a startup time of ~200 ps.

In several embodiments of the invention, the waveform of the transmit signal is locked to the phase and/or formation of the receive signal. Various embodiments of the invention may utilize different data transmission techniques.

In further embodiments of the invention, the location of a wireless powered transceiver can be determined. For example, a reader device can receive the transceiver's transmitted signal. The frequency and phase of the transmitted signal can be used to determine the distance between the transceiver and the reader device. Multiple distances can be determined by moving the reader device or by using multiple antennas on the reader device. A location can be determined for the transceiver using the multiple determined distances.

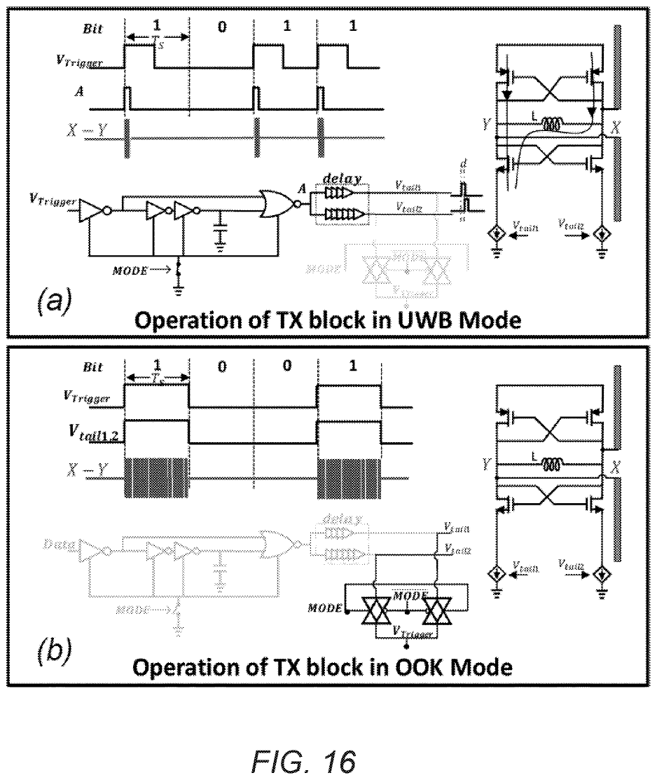

Although a specific transmitter circuitry is described above with respect to FIGS. 15 and 16, one skilled in the art would recognize that variations may be made (e.g., using other appropriate frequencies and/or modulation schemes) or other circuitry may be utilized in accordance with embodiments of the invention as appropriate to a particular application.

Although specific methods of closed-loop HNS treatment are discussed above, many different methods can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A system for hypoglossal nerve stimulation (HNS), the system comprising:
a wearable device comprising at least one sensor, wherein the wearable device is configured to:
receive a control input describing stimulation data;
provide a radio frequency (RF) signal from the wearable device to at least one wirelessly powered stimulator based on the control input; and
monitor, using the at least one sensor, at least one physiological signal of a subject implanted with at least one wirelessly powered stimulator;
the at least one wirelessly powered stimulator, each wirelessly powered stimulator comprising an implantable pulse generator comprising:
a rectifier;
a rechargeable battery configured to be charged by the rectifier using energy from the RF signal;
a demodulator; and
an output voltage regulator;
where each implantable pulse generator is configured to:
receive the RF signal;
charge the rechargeable battery using energy from the RF signal; and
output a stimulation using energy stored in the rechargeable battery in an output pulse having characteristics based on the received RF signal; and
a controller device capable of providing the control input describing stimulation data.

2. The system of claim 1, wherein the at least one sensor comprises at least one selected from: an Electromyography (EMG) sensor, Electroencephalography (EEG), Electrooculography (EOG), a reflective photoplethysmography (PPG) sensor, an acoustic sensor, a piezoelectric sensor, a MEMS sensor, an accelerometer, a magnetometer, a gyroscope, and camera.

3. The system of claim 1, wherein the at least one physiological signal is selected from the group consisting of: oxygen saturation levels; AHI index; snoring sounds; body position; respiratory effort; respiratory rate; heart rate; heart rate variability; apneas; and hypopneas.

4. The system of claim 1, wherein the at least one physiological signal comprises a stage of sleep, wherein the stage of sleep comprises: Rapid Eye Movement (REM), Non-Rapid Eye Movement (NREM), Stage N1 (Light Sleep), Stage N2 (Deeper Light Sleep), and Stage N3 (Deep Sleep/Slow-Wave Sleep).

5. The system of claim 4, wherein the controller device is configured to apply different stimulation parameters during different detected stages of sleep.

6. The system of claim 1, wherein the controller device is capable of adjusting and outputting the stimulation based on the monitored at least one physiological signal.

7. The system of claim 1, wherein the controller device utilizes machine learning algorithms to dynamically adjust stimulation parameters based on the monitored at least one physiological signal.

8. The system of claim 7, wherein the machine learning algorithms comprise at least one selected from: reinforcement learning, convolutional neural networks (CNNs), long short-term memory (LSTM) networks, and temporal convolutional networks (TCNs).

9. The system of claim 1, wherein data from the at least one sensor is synchronized and analyzed in real time to provide a multimodal evaluation of sleep-related breathing disorder events.

10. The system of claim 1, wherein the implantable pulse generator utilizes a voltage-controlled stimulation (VCS) scheme in which a VDD node is directly applied to an electrode with a controllable pulse width.

11. The system of claim 1, wherein the implantable pulse generator further comprises a transmitter configured to transmit data to the wearable device, and wherein the wearable device is configured to adjust the RF signal based on the transmitted data from the implantable pulse generator.

12. The system of claim 1, wherein the at least one sensor is located on at least one of the wearable device or the implantable pulse generator.

13. A system for hypoglossal nerve stimulation (HNS), the system comprising:
a wearable device comprising at least one sensor, wherein the wearable device is configured to:
receive a control input describing stimulation data;
provide a radio frequency (RF) signal from the wearable device to at least one wirelessly powered stimulator based on the control input; and
monitor, using the at least one sensor, at least one physiological signal of a subject implanted with at least one wirelessly powered stimulator;
the at least one wirelessly powered stimulator, each wirelessly powered stimulator comprising an implantable pulse generator comprising:
a rectifier;
an energy storage capacitor;
a demodulator; and
an output voltage regulator;
where each implantable pulse generator is configured to:
receive and recover power from the RF signal; and
output a stimulation that releases the energy stored in the energy storage capacitor on a plurality of electrodes in an output pulse having characteristics based on the received RF signal; and
a controller device capable of providing the control input describing stimulation data.

14. The system of claim 13, wherein the at least one sensor comprises at least one selected from: an Electromyography (EMG) sensor, Electroencephalography (EEG), Electrooculography (EOG), a reflective photoplethysmography (PPG) sensor, an acoustic sensor, a piezoelectric sensor, a MEMS sensor, an accelerometer, a magnetometer, a gyroscope, and a camera.

15. The system of claim 13, wherein the at least one physiological signal is selected from the group consisting of: oxygen saturation levels; AHI index; snoring sounds; body position; respiratory effort; respiratory rate; heart rate; heart rate variability; apneas; and hypopneas.

16. The system of claim 13, wherein the at least one physiological signal comprises a stage of sleep, wherein the stage of sleep comprises: Rapid Eye Movement (REM), Non-Rapid Eye Movement (NREM), Stage N1 (Light Sleep), Stage N2 (Deeper Light Sleep), and Stage N3 (Deep Sleep/Slow-Wave Sleep).

17. The system of claim 16, wherein the controller device is configured to apply different stimulation parameters during different detected stages of sleep.

18. The system of claim 13, wherein the controller device is capable of adjusting and outputting the stimulation based on the monitored at least one physiological signal.

19. The system of claim 13, wherein the controller device utilizes machine learning algorithms to dynamically adjust stimulation parameters based on the monitored at least one physiological signal.

20. The system of claim 13, wherein data from the at least one sensor is synchronized and analyzed in real time to provide a multimodal evaluation of sleep-related breathing disorder events.

21. A method for treating obstructive sleep apnea (OSA) in a subject, the method comprising:
providing a radio frequency (RF) signal from a wearable device to a wirelessly powered implantable pulse generator (IPG) implanted in the subject proximate to the hypoglossal nerve;
recovering, by the IPG, power from the RF signal;
outputting, by the IPG using the recovered power, a stimulation to the hypoglossal nerve of the subject in an output pulse having characteristics based on the received RF signal;
monitoring, by the wearable device, at least one physiological signal of the subject;
generating, by a controller device, an adjusted control input describing stimulation data based on the monitored at least one physiological signal; and
providing an adjusted RF signal from the wearable device to the IPG based on the adjusted control input.

22. The method of claim 21, wherein monitoring the at least one physiological signal comprises monitoring at least one selected from the group consisting of: oxygen saturation levels; AHI index; snoring sounds; body position; respiratory effort; respiratory rate; heart rate; heart rate variability; apneas; and hypopneas.

23. The method of claim 21, further comprising classifying a sleep stage of the subject based on the monitored at least one physiological signal, and applying different stimulation parameters during different classified stages of sleep.

24. The method of claim 21, wherein recovering power from the RF signal comprises rectifying the RF signal and storing recovered power in an energy storage capacitor.

25. The method of claim 21, wherein recovering power from the RF signal comprises rectifying the RF signal and charging a rechargeable battery.

26. The method of claim 21, wherein the adjusted control input is encoded in the RF signal using a notch-based modulation scheme in which RF power is reduced to a percentage of RF power during harvest to encode stimulation parameters such as timing, amplitude, frequency, pulse-width.

27. The method of claim 21, wherein generating the adjusted control input comprises utilizing machine learning algorithms to dynamically adjust stimulation data based on the monitored at least one physiological signal.

28. A wearable device for wireless powering and closed-loop control of an implantable pulse generator, the wearable device comprising:
a radio frequency (RF) transmitter coil configured to transmit a wireless signal to wirelessly power the implantable pulse generator;
a plurality of physiological sensors comprising at least a blood oxygen saturation sensor, an acoustic sensor, and a motion sensor;
a wireless communication module configured to communicate with a controller device; and
a processor configured to:
acquire physiological data from the plurality of physiological sensors;
process the physiological data using at least one machine learning algorithm; and
modulate the wireless signal to encode adjusted stimulation data based on the processed physiological data.

29. The wearable device of claim 28, wherein the at least one machine learning algorithm comprises a Long Short-Term Memory (LSTM) network or Temporal Convolutional Network (TCN) for processing blood oxygen saturation data.

30. The wearable device of claim 28, wherein the at least one machine learning algorithm comprises a Convolutional Neural Network (CNN) for classifying apneic events from acoustic sensor data.

31. The wearable device of claim 28, wherein the RF transmitter coil is configured to transmit the wireless signal at an ISM band between 1 MHz and 100 MHz.

32. The wearable device of claim 28, wherein the motion sensor is a three-axis accelerometer.
